(19) United States
(12) Patent Application Publication
(10) Pub. No.: US 2007/0114413 A1
(43) Pub. Date: May 24, 2007

(54) Integrated detecting processor

(76) Inventors: James Parker, Temple City, CA (US); Randall Wang, Temple City, CA (US)

Correspondence Address: Raymond Y. Chan, Suite 128, 108 N. Ynez Ave., Monterey Park, CA, 91754, US

(21) Appl. No.: 11/282,362

(22) Filed: Nov. 18, 2005

(51) Int. Cl. G01J 5/00

(52) U.S. Cl. 250/338.3

(57) ABSTRACT

An infrared sensor includes an infrared generator for generating infrared radiation within a detecting area, a pyroelectric sensor, a microprocessor, and an integrated detecting processor. The pyroelectric sensor is electrically communicated with the infrared generator, wherein the infrared radiation as an input signal is converted into a DC signal as an output signal having a real signal with low frequency and a noise signal mixed therewith. The microprocessor includes an A/D converter electrically connected with the pyroelectric sensor, wherein the microprocessor is arranged to receive the DC signal for data processing. The integrated detecting processor, which is electrically connected with the microprocessor, is adapted for stripping out the DC signal from the pyroelectric sensor to control a DC level of the DC signal, such that the real signal is allowed to be accurately processed in the microprocessor without data overflowing.

### BACKGROUND OF THE PRESENT INVENTION

1. Field of Invention

The present invention relates to a infrared sensor, and more particularly to an integrated detecting processor employed in the infrared sensor for minimizing the frequency of false alarm, and maximizing the sensitivity of the infrared sensor.

2. Description of Related Arts

A conventional motion sensor usually comprises a sensor casing, an infrared generator provided on the sensor casing for emitting infrared radiation, preferably through a specifically designed lens provided on the sensor casing, out of the sensor casing to detect a movement of a physical object within a detecting area, and a pyroelectric sensing module provided in the sensor casing for detecting and processing infrared energy reflected from the infrared radiation generated by the infrared generator, and a microprocessor (which may comprise an analog-to-digital converter) for compiling an electrical signal outputted from the pyroelelctric sensing module so as to recognize a physical movement in the detecting area.

More specifically, the pyroelectric sensing module usually comprises a signal input communicated with the infrared generator to receive an infrared signal created by infrared radiation reflected from the detecting area, a signal output adapted for producing a predetermined level of output signal in responsive to the infrared signal, wherein the output signal is fed into the microprocessor for further analysis for recognizing the physical movement in the detecting area.

A major problem for this conventional motion sensor is that the output signal of the pyroelectric sensing module is very low (typically in the order of milli-volts) so that the output signal corresponding with actual physical movement within the detecting area is easily superseded by surrounding noise or other factors which may affect the infrared energy received by the pyroelectric sensing module. As a result, the overall performance of the motion sensor will be inaccurate.

In order to cater for this problem, the motion sensor may further comprise a signal filtering circuitry and a signal amplifying circuitry electrically connected with the pyroelectric sensing module, wherein the output signal of the pyroelectric sensing module is fed into the signal filtering circuitry and the signal amplifying circuitry which are arranged to filter noise signal and amplify the remaining signal respectively for further processing of the output signal of the pyroelectric sensing module. In short therefore, some signals are removed from the output signal when it has passed through the signal filtering circuitry and the signal amplifying circuitry.

A persistent problem with this signal filtering and signal amplifying strategies is that it is possible that those portions of signal which reflect the actual physical movement, as opposed to surrounding noise, may be mistakenly removed by the signal filtering circuitry so that actual physical movement within the detecting area may not be successfully detected. On the other hand, those portions of output signal which reflect surrounding noise or any other environmental factors may be mistakenly interpreted as an actual physical movement in the detecting area so that false alarm may be produced as a result.

Another problem of this kind of conventional motion sensor is that it is usually expensive because of the various circuitries which are incorporated into the motion sensor for catering the above-mentioned problems.

### SUMMARY OF THE PRESENT INVENTION

A main object of the present invention is to provide an infrared sensor sensing physical movement in a detecting area, wherein the infrared sensor comprises an integrated detecting processor which is adapted to supplement a regulated DC signal to an output signal of the pyroelectric sensor in the infrared sensor so as to improve the quality of those portions of output signals corresponding with an actual physical movement within the detecting area for maximizing an overall performance of the infrared sensor and overcoming the above-mentioned problems of conventional motion sensors.

Another object of the present invention is to provide an infrared sensor which comprises an integrated detecting processor which is adapted to supplement a specifically controlled DC signal to an output signal of the pyroelectric sensor in the infrared sensor so that a microprocessor of the infrared sensor is supplied with an optimal level of electrical signal for performing accurate and sensitive measurement of the physical movement within the detecting area.

Another object of the present invention is to provide an infrared sensor which comprises an integrated detecting processor controlled by a specifically designed algorithm, so that the integrated detecting processor is capable of adapting to a wide range of situations (such as DC signal deterioration by the pyroelectric sensor) to maintain the optimal level of electric signal supplied to the microprocessor.

Another object of the present invention is to provide an infrared sensor which can substantially overcome the above-mentioned problems without utilizing complicated mechanical or electrical components, so as to minimize the manufacturing cost as well as the ultimate selling price of the present invention.

Accordingly, the present invention provides an infrared sensor, comprising:

an infrared generator for generating infrared radiation within a detecting area;

a pyroelectric sensor electrically communicated with said infrared generator, wherein said infrared radiation as an input signal is converted into a DC signal as an output signal through said pyroelectric sensor, wherein said DC output signal has a real signal with low frequency and a noise signal mixed therewith;

a microprocessor which comprises a A/D converter electrically connected with said pyroelectric sensor, wherein said microprocessor is arranged to receive said DC signal for data processing so as to determine whether a target locating within said detecting area; and

an integrated detecting processor, which is electrically connected with said microprocessor, adapted for stripping out said DC signal from said pyroelectric sensor to control a DC level of said DC signal, such that said real signal is allowed to be accurately processed in said microprocessor without data overflowing.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of an infrared sensor according to a preferred embodiment of the present invention.

FIG. 2 is a circuit diagram of the infrared sensor according to the above preferred embodiment of the present invention.

FIG. 3 is a perspective view of the infrared sensor according to the above preferred embodiment of the present invention.

FIG. 4 is a method of sensing motion by the infrared sensor according to the above preferred embodiment of the present invention.

### DETAILED DESCRIPTION OF THE PREFERRED EMBODIMENT

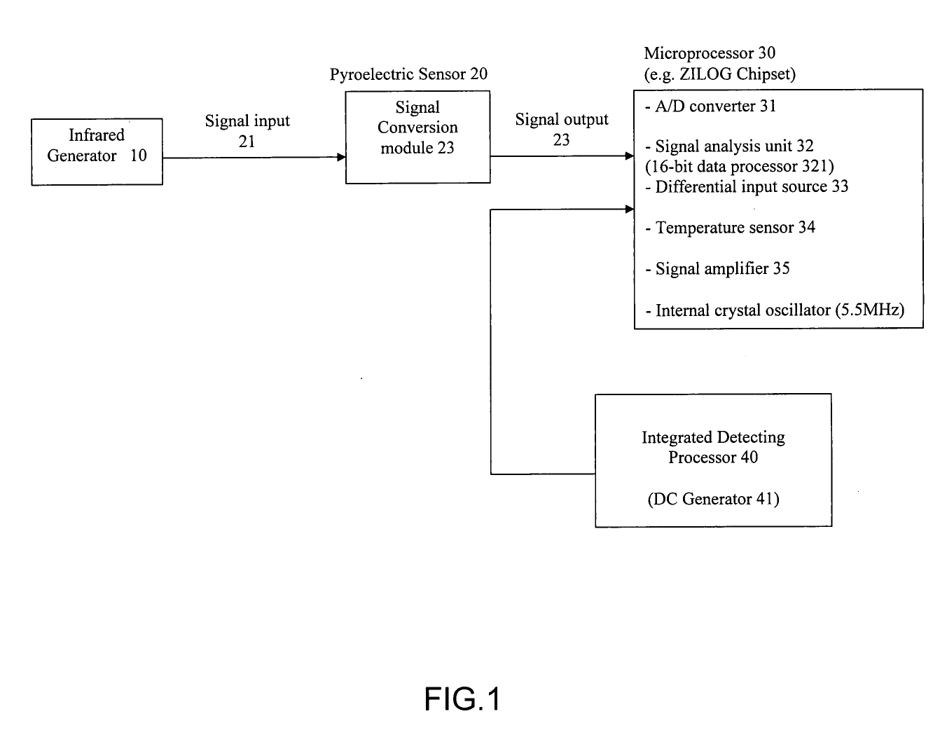

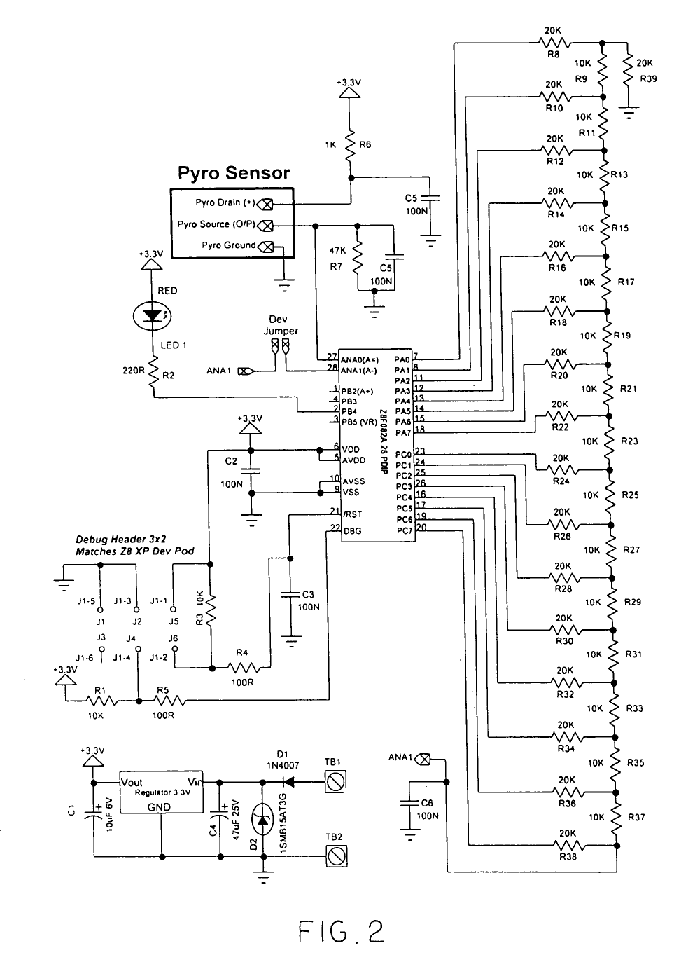

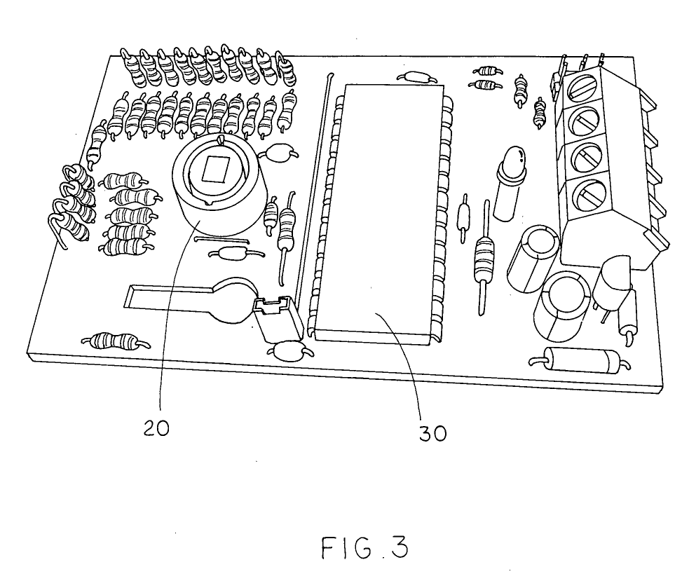

Referring to FIG. 1 to FIG. 3 of the drawings, an infrared sensor, such as a motion sensor, according to a preferred embodiment of the present invention is illustrated. According to the preferred embodiment, the infrared sensor comprises an infrared generator 10 for generating infrared radiation within a detecting area, a pyroelectric sensor 20, a microprocessor 30, and an integrated detecting processor 40.

The pyroelectric sensor 20 is electrically communicated with the infrared generator 10, wherein the infrared radiation as an input signal is converted into a DC signal as an output signal through the pyroelectric sensor 20, wherein the DC output signal has a real signal with low frequency and a noise signal mixed therewith.

Thus, the pyroelectric sensor 20 has a signal input 21 adapted to receive infrared energy of the reflected infrared radiation, a signal conversion module 22 electrically connected with the signal input 21 for converting the infrared energy to the DC output signal, and a signal output 23 electrically connecting with the signal conversion module 22 for outputting the DC output signal.

The microprocessor 30, such as a ZLOG chipset, comprises a A/D converter 31 electrically connected with the pyroelectric sensor 20, wherein the microprocessor 30 is arranged to receive the DC signal for data processing so as to determine whether a target is locating within the detecting area.

Thus, the microprocessor 30 is electrically connected with the pyroelectric sensor 20 to receive the pyroelectric DC signal for interpreting the pyroelectric DC signal so as to measure the corresponding physical motion in the detecting area.

The integrated detecting processor 40, which is electrically connected with the microprocessor 30, is adapted for stripping out the DC signal from the pyroelectric sensor 20 to control a DC level of the DC signal, such that the real signal corresponding with the physical movement in the detecting area is allowed to be accurately processed in the microprocessor 30 without data overflowing.

In other words, the integrated detecting processor 40 is electrically connected with the microprocessor 30, wherein the integrated detecting processor 40 is programmed to feed an offset DC signal to the microprocessor, wherein the offset DC signal is intelligently adjusted to correspond with the DC output signal in such a manner to optimize an overall signal input to the microprocessor 30, so that the microprocessor 30 is supplied with an optimal DC input signal for performing accurate manipulation as to the physical motion in the detecting area.

According to the preferred embodiment of the present invention, the integrated detecting processor 40 comprises a DC generator 41 having the same DC resolution of the microprocessor 30.

The pyroelectric sensor 20 is adapted to generate the DC output signal which corresponds to an infrared energy differential between the outgoing infrared radiation and the received infrared radiation.

On the other hand, the microprocessor 30 comprises a signal analysis unit 32 electrically connecting with the A/D converter 31 for statistically analyzing the DC signal, wherein the signal analysis unit statistically collects a plurality of sample data from the DC signal via a time domain to dynamically control the sample data by itself, wherein a control range of the DC signal is determined from the sample data in such a manner that when the sample data falls out of the control range, the sample data is considered as the noise signal to be discarded from the DC signal, so as to accurately process the real data with low frequency in the DC signal in the A/D converter.

The microprocessor 30 further comprises a differential input source 33 electrically coupling with the pyroelectric sensor 20 to measure a difference between the two signals from the DC generator 41 and the pyroelectric sensor 20.

Moreover, the microprocessor 30 further comprises a temperature sensor 34 for determining a temperature of the target with respect to an ambient temperature so as to control a sensitivity of the microprocessor 30. The microprocessor 30 further comprises a signal amplifier 35 amplifying the DC signal with the real signal before sending to the A/D converter 31.

The microprocessor 30 is preferably embodied as a ZLOG chip set (1K of RAM and 8K of ROM) which comprises the A/D converter 31, and the signal amplifier 35, wherein the DC output signal is fed into the microprocessor 30 and is amplified and converted into digital signal which is then further manipulated to reflect the physical motion of the detecting area.

Moreover, the microprocessor further comprises an internal 5.5 Mhz crystal oscillators, wherein the infrared energy of the radiation is affected by the ambient temperature, signal analysis taken place at the microprocessor 30 need to be adjusted to take into account any change in ambient temperature as detected by the temperature sensor 34.

The microprocessor has a positive terminal and a negative terminal for signal input, wherein the positive terminal is electrically connected with the pyroelectric sensor 20, while the negative terminal is electrically connected with the integrated detecting processor 40, wherein the DC output signal is negated by the offset DC signal generated from the integrated detecting processor 40 for constituting the differential input source 33 so as to optimize the DC output signal feeding into the microprocessor 30 for optimally accurately calculating the physical motion with the detecting area.

According to the preferred embodiment of the present invention, the signal analysis unit 32 comprises a data processor 321 statistically determining the control range to form an upper control limit and a lower control limit of the data, wherein a range between the upper and lower control limits is determined in term of numbers of standard deviation from the sample data within the time domain.

The data processor 321 is preferably a n-bit processor statistically takes n sample data at one time to form a single sample for data analysis, so as to increase a resolution of the A/D converter 31 by over sampling (e.g. a 16-bit data processor 321).

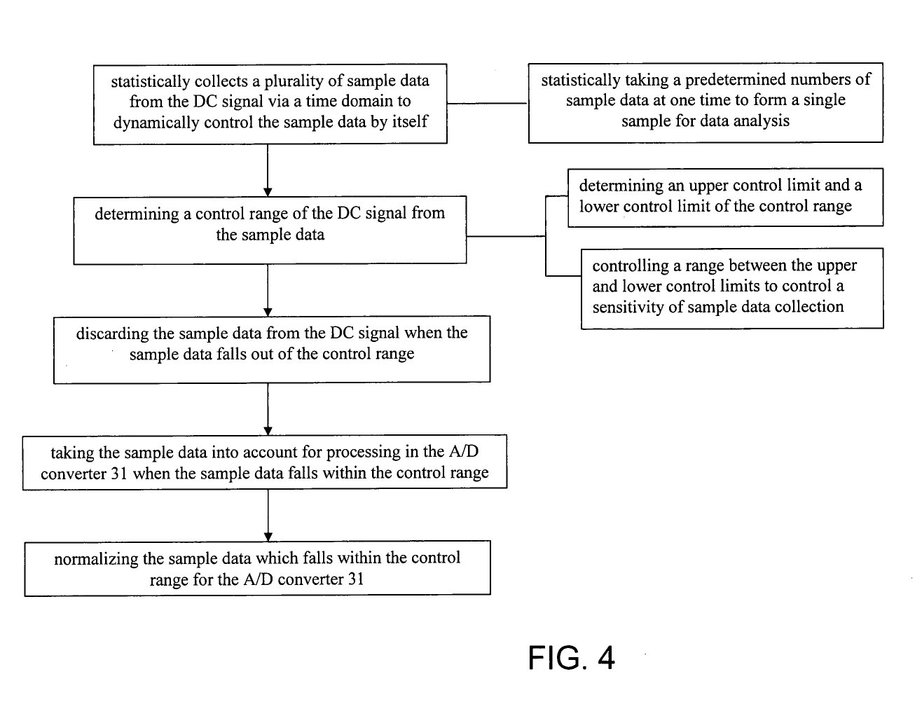

Referring to FIG. 4 of the drawings, a method of analyzing DC signals for an A/D converter 31 is illustrated, wherein the method comprises the steps of:

(a) statistically collects a plurality of sample data from the DC signal via a time domain to dynamically control the sample data by itself;

(b) determining a control range of the DC signal from the sample data;

(c) discarding the sample data from the DC signal when the sample data falls out of the control range; and

(d) taking the sample data into account for processing in the A/D converter 31 when the sample data falls within the control range.

Step (a) further comprises a step of statistically taking a predetermined numbers of sample data at one time to form a single sample for data analysis, so as to increase a resolution of the A/D converter 31 by over sampling.

Step (b) comprises a step of determining an upper control limit and a lower control limit of the control range, wherein a range between the upper and lower control limits is determined in term of numbers of standard deviation from the sample data within the time domain.

Thus, step (b) further comprises a step of controlling a range between the upper and lower control limits to control a sensitivity of sample data collection.

In order to effectively analyzing the signal detected by the infrared sensor, the method further comprises a step of normalizing the sample data which falls within the control range for the A/D converter 31. As such, the sample date can be normalized to be further processed for interpreting the detected motion within the detecting area. Note that a preferred normalization factor is 255.

From the forgoing descriptions, it can be shown that the above-mentioned objects have been substantially accomplished. The present invention provides the infrared sensor and the method thereof for sensing physical movement in a detecting area, wherein the infrared sensor comprises the integrated detecting processor 40 which is adapted to supplement a regulated DC signal to an output signal of the pyroelectric sensor 30 in the infrared sensor so as to improve the quality of those portions of output signals corresponding with an actual physical movement within the detecting area for maximizing an overall performance of the infrared sensor.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An infrared sensor, comprising:
an infrared generator for generating infrared radiation within a detecting area;
a pyroelectric sensor electrically communicated with said infrared generator, wherein said infrared radiation as an input signal is converted into a DC signal as an output signal through said pyroelectric sensor, wherein said DC output signal has a real signal with low frequency and a noise signal mixed therewith;
a microprocessor which comprises a A/D converter electrically connected with said pyroelectric sensor, wherein said microprocessor is arranged to receive said DC signal for data processing so as to determine whether a target locating within said detecting area; and
an integrated detecting processor, which is electrically connected with said microprocessor, adapted for stripping out said DC signal from said pyroelectric sensor to control a DC level of said DC signal, such that said real signal is allowed to be accurately processed in said microprocessor without data overflowing.

2. The infrared sensor, as recited in claim 1, wherein said integrated detecting processor comprises a DC generator having the same DC resolution of said microprocessor.

3. The infrared sensor, as recited in claim 1, wherein said microprocessor further comprises a signal analysis unit electrically connecting with said A/D converter for statistically analyzing said DC signal, wherein said signal analysis unit statistically collects a plurality of sample data from said DC signal via a time domain to dynamically control said sample data by itself, wherein a control range of said DC signal is determined from said sample data in such a manner that when said sample data falls out of said control range, said sample data is considered as said noise signal to be discarded from said DC signal, so as to accurately process said real data with low frequency in said DC signal in said A/D converter.

4. The infrared sensor, as recited in claim 2, wherein said microprocessor further comprises a signal analysis unit electrically connecting with said A/D converter for statistically analyzing said DC signal, wherein said signal analysis unit statistically collects a plurality of sample data from said DC signal via a time domain to dynamically control said sample data by itself, wherein a control range of said DC signal is determined from said sample data in such a manner that when said sample data falls out of said control range, said sample data is considered as said noise signal to be discarded from said DC signal, so as to accurately process said real data with low frequency in said DC signal in said A/D converter.

5. The infrared sensor, as recited in claim 3, wherein said microprocessor further comprises a differential input source electrically coupling with said pyroelectric sensor to measure a difference between two signals from said DC generator and said pyroelectric sensor.

6. The infrared sensor, as recited in claim 4, wherein said microprocessor further comprises a differential input source electrically coupling with said pyroelectric sensor to measure a difference between two signals from said DC generator and said pyroelectric sensor.

7. The infrared sensor, as recited in claim 4, wherein said microprocessor further comprises a temperature sensor for determining a temperature of said target with respect to an ambient temperature so as to control a sensitivity of said microprocessor.

8. The infrared sensor, as recited in claim 6, wherein said microprocessor further comprises a temperature sensor for determining a temperature of said target with respect to an ambient temperature so as to control a sensitivity of said microprocessor.

9. The infrared sensor, as recited in claim 6, wherein said microprocessor further comprises a signal amplifier amplifying said DC signal with said real signal before sending to said A/D converter.

10. The infrared sensor, as recited in claim 8, wherein said microprocessor further comprises a signal amplifier amplifying said DC signal with said real signal before sending to said A/D converter.

11. A microprocessor for infrared sensor having a DC signal, comprising:
a A/D converter; and
a signal analysis unit electrically connecting with said A/D converter for statistically analyzing said DC signal, wherein said signal analysis unit statistically collects a plurality of sample data from said DC signal via a time domain to dynamically control said sample data by itself, wherein a control range of said DC signal is determined from said sample data in such a manner that when said sample data falls out of said control range, said sample data is considered as a noise signal to be discarded from said DC signal, so as to accurately process a real data with low frequency in said DC signal in said A/D converter.

12. The microprocessor, as recited in claim 11, wherein said signal analysis unit comprises a data processor statistically determining said control range to form an upper control limit and a lower control limit, wherein a range between said upper and lower control limits is determined in term of numbers of standard deviation from said sample data within said time domain.

13. The microprocessor, as recited in claim 12, wherein said data processor is a n-bit processor statistically takes n sample data at one time to form a single sample for data analysis, so as to increase a resolution of said A/D converter by over sampling.

14. The microprocessor, as recited in claim 13, wherein said data processor is a 16-bit processor statistically takes 16 sample data at one time.

15. The microprocessor, as recited in claim 11, further comprising a temperature sensor incorporating with said infrared sensor to control a sensitivity of said microprocessor.

16. The microprocessor, as recited in claim 14, further comprising a temperature sensor incorporating with said infrared sensor to control a sensitivity of said microprocessor.

17. A method of analyzing DC signal for A/D converter, comprising the steps of:
(a) statistically collects a plurality of sample data from said DC signal via a time domain to dynamically control said sample data by itself;
(b) determining a control range of said DC signal from said sample data
(c) discarding said sample data from said DC signal when said sample data falls out of said control range; and
(d) taking said sample data into account for processing in said A/D converter when said sample data falls within said control range.

18. The method as recited in claim 17, in step (a), further comprising a step of statistically taking a predetermined numbers of sample data at one time to form a single sample for data analysis, so as to increase a resolution of said A/D converter by over sampling.

19. The method as recited in claim 17, in step (b), further comprising a step of determining an upper control limit and a lower control limit of said control range, wherein a range between said upper and lower control limits is determined in term of numbers of standard deviation from said sample data within said time domain.

20. The method as recited in claim 18, in step (b), further comprising a step of determining an upper control limit and a lower control limit of said control range, wherein a range between said upper and lower control limits is determined in term of numbers of standard deviation from said sample data within said time domain.

21. The method as recited in claim 19, in step (b), further comprising a step of controlling a range between said upper and lower control limits to control a sensitivity of sample data collection.

22. The method as recited in claim 20, in step (b), further comprising a step of controlling a range between said upper and lower control limits to control a sensitivity of sample data collection.

23. The method, as recited in claim 17, further comprising a step of normalizing said sample data which falls within said control range for said A/D converter.

24. The method, as recited in claim 22, further comprising a step of normalizing said sample data which falls within said control range for said A/D converter.
